(19) United States
(12) Patent Application Publication
(10) Pub. No.: US 2022/0207582 A1
(43) Pub. Date: Jun. 30, 2022

(54) GROUP BUYING CAMPAIGN

(71) Applicant: POM and Go Private Limited, Mumbai (IN)

(72) Inventors: JAGDISH CHANDRA BELWAL, Pune (IN); YAMINI BELWAL, Pune (IN); AMOL GUPTA, Cumming, GA (US); MAHESH GUPTA, Cumming, GA (US); SHWETA RAJIV PANDEY, Thane (IN)

(73) Assignee: POM and Go Private Limited, Mumbai (IN)

(21) Appl. No.: 17/401,311

(22) Filed: Aug. 13, 2021

(30) Foreign Application Priority Data
Dec. 28, 2020 (IN) 202021056644

(51) Int. Cl. G06Q 30/06; G06Q 40/02

(52) U.S. Cl. CPC G06Q 30/0611; G06Q 30/0631; G06N 20/00; G06Q 40/025; G06Q 30/0619

(57) ABSTRACT

Described herein is a method and platform for conducting a buying campaign of a cohort of a plurality of buyers and suppliers. An online platform enables engagement, collaboration and sharing with buyers and suppliers. A lead moderator orchestrates the buying campaign. Preference parameters and nano segments are created. A nano segment is a small group of consumers with a multiplicity of matching profile demographic and background criteria. A buying campaign can be split into sub campaigns with additional moderators supporting the campaign moderator. The buyers co-create the specific products and services along with the suppliers in order to create a highly tailored experience for the nano segment involved. AI algorithms augment the experience by providing product, add ons, and participant recommendations to the moderator and buyers.

### CROSS-REFERENCE TO RELATED PATENT APPLICATIONS

The present application claims the benefit of priority to Indian Patent Application No. 202021056644, entitled “Group buying campaign” filed on Dec. 28, 2020, the entire contents of which are hereby incorporated by reference herein.

### TECHNICAL FIELD OF THE INVENTION

This invention in general relates to a platform for ecommerce, and specifically refers to a method and system for group buying.

### BACKGROUND OF THE INVENTION

This invention in general relates to ecommerce and specifically refers to a collaborative transaction platform.

In today's consumer facing market, demand is dictated by price which in turn is shaped by marketing, promotions, cross selling schemes, and loss leader promotions. The default assumption is that consumer demand is fluid and can be shaped by price and promotions. Consumers have no control on price or demand except being motivated by price and promotions. This is manifested in all mass stores such as Walmart, Macys, etc.

A variation to the consumer demand shaping model is conducted by “Club” stores such as Costco, Sam's Club; who have strong consumer data to predict demand, negotiate bulk prices and give its members the power of bulk demand. However, these “club” stores are no longer differentiated as mass stores like Walmart, Macys, etc. are driving consumer insights using loyalty models.

Conversely, businesses have always been able to drive better bargains compared to consumers. This is because businesses are better able to collate demand within the enterprise; and many times within their ecosystem to give a predictable, contracted demand to sellers. In this manner they are able to drive prices down—including by reverse auction of demand to sellers.

In the current market model, there is an unmet need and opportunity to use the power of technology, social networks and platform business models in consumer markets to question the default assumption of price driving demand.

### SUMMARY

The invention disclosed herein addresses the abovementioned unmet need.

Advantageously, the ecommerce model disclosed herein creates a known and committed demand and offers a win-win to consumers and service providers alike. Consumers get better deals, customised packages, and convenience. Sellers save money on campaigns, get predictable demand, can plan better and can provide a better experience to highly converged consumer segments. Sellers can also offer alternative product-price points on the same campaign to assess their potential offerings.

Advantageously, the ecommerce platform disclosed herein supports profitability by generating revenue from commission in lieu of giving bulk demand to sellers saving money on price promotions, advertising and campaigns; generates revenue from consumers who are benefiting from a successful campaign and invests consumer committed funds in money markets to generate interest income.

Advantageously, the ecommerce platform disclosed herein targets segments based on complexity and business value. The user profile captures attributes base on communities, life stage (for example, singles, just married, toddlers, teenagers, grown up kids, oldies, widowers), sports and interests (for example, football, baseball, local club), alumni (for example, school, college, organisation, non-profit) and geo based (for example, city, locality, church member, club member, etc.). These highly specific customer segments are termed as Nano Segments.

Advantageously, the ecommerce platform disclosed herein covers a wide range of products and services. For example, it organizes charter flights, group vacations, big ticket items >1K USD:Primarily customisable products like cars, yachts, houses/apartments, events, organising world cup outings for groups, mass transport nano-segments to go from housing complexes to commercial complexes for work, and small business B2B coming together and buying in bulk.

Described herein is a campaign with a lead buyer setting Nano Segment rules, characteristics, campaign details, and inviting the targeted Nano Segment customers to purchase together. For example, a low handicap golfer can start a campaign to buy a high end golf set together with other interested low handicap golfers of his club. The Nano Segment here is low handicap golfers of a particular golf club. This Nano Segment is defined by the moderator and is enabled by the platform to join the campaign and buy together.

Described herein is a campaign specific product or service co-creation between a customer group and supplier. The campaign based buying process enabled by the online platform, brings together the customer cohort and the supplier to collaborate and co-create an experience highly fitted to the customer Nano Segment characteristics. For example, a customer cohort defined by a Nano Segment-families with infants; is able to create an itinerary for a vacation highly customised with suitable activities and support for parents with infants.

### BRIEF DESCRIPTION OF DRAWINGS

FIG. 1 illustrates the method of conducting a buying campaign of a cohort of a plurality of buyers and suppliers.

FIG. 2 illustrates the functional modules of the overall architecture of the system.

FIG. 3 illustrates the process solution for aggregating customers' demands for group buying of products or services.

FIG. 4 illustrates the user registration process.

FIG. 5 illustrates the supplier registration process.

FIG. 6 illustrates Nano Segment relationships.

FIG. 7 illustrates the campaign creation.

FIG. 8 illustrates campaign management.

FIG. 9 illustrates addon products and services.

FIG. 10 illustrates a subscribe campaign

FIG. 11 illustrates a sub-campaign creation.

FIG. 12 illustrates campaign fulfilment by a supplier.

FIG. 13 illustrates campaign fulfilment by a moderator.

FIG. 14 illustrates the ordering process in campaign fulfilment.

FIG. 15 illustrates the review and feedback process.

### DETAILED DESCRIPTION

### Definition of Terms

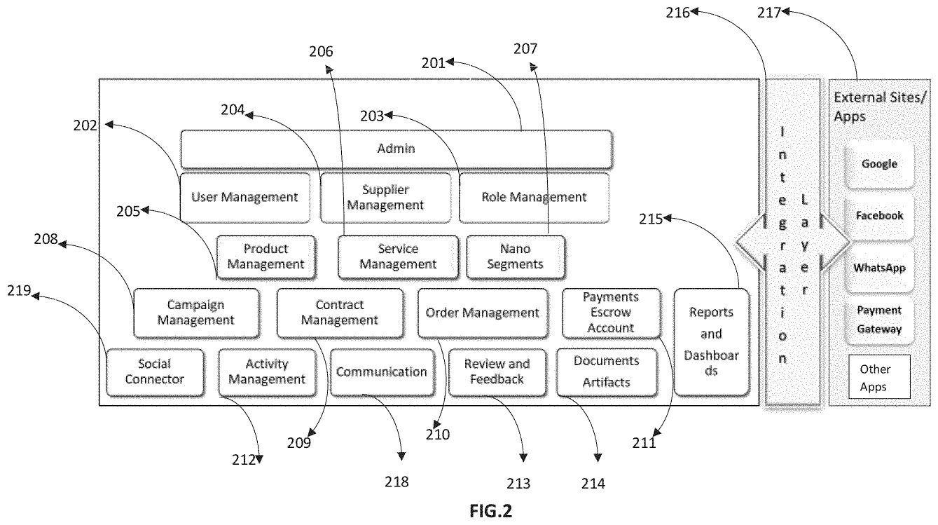

Platform: Platform is a computer implemented online system encompassing all the modules and roles described here. The Platform will run all the processes and orchestrate business transactions. The platform comprises of all the elements from 201 to 216 in FIG. 2.

Role: Role is defined as a function the user will play in the application. The role will be associated with every user and defines the user access to role specific modules, records, entities and processes in the application.

Supplier: Supplier is defined as a company or an individual who will provide the products or the services. This entity will have access to the product/service catalogue to select the offered product and service.

Campaign: Campaign is defined as an entity that will be used by users to define the demand of product and or services for an event. Campaign, for example, will have attributes such as name, description, event duration, event date, maximum members, Nano Segment, Products/Services required.

Concierge: Concierge is defined as a role provided by the platform that will assist in the campaign creation and its fulfilment. A concierge aggregates products and services across multiple suppliers on behalf of the moderator and the participating buyers of nano segment. It will assist the campaign moderator and campaign members to achieve a unique user experience with the help of service or product customization.

Moderator: Moderator is a type of user who initiates or creates the campaign, leads the campaign on behalf of its participants, modifies to keep it updated based on other user's responses, is the single point of contact for suppliers and concierge, and takes appropriate action on the campaign at every stage as per the campaign creation process.

Nano Segment: Nano Segment is defined as a small group of consumers with a multiplicity of matching profile demographic and background criteria. Consumers in a Nano Segment are likely to have closely matching requirements for products and services. These requirements, when identified in a collaborative manner can be fulfilled to create a great and unique experience. Campaigns, moderators, users, products, services will be associated with one or more Nano Segments. One consumer can be part of multiple Nano Segments, for example her club members as well as her college batch.

Campaign Member: A campaign member is a type of user whose profile matches the Nano Segment definition, can view the campaign in the application, participate in the existing campaign as per the campaign registration process, and take on additional roles to support the moderator, for example sub campaign moderator or handling a specific supplier.

Admin/Superuser is a user profile that has administrative access over the application for the purpose of maintenance, verification of users accessing the application, publishing advertisement or feedback reviews.

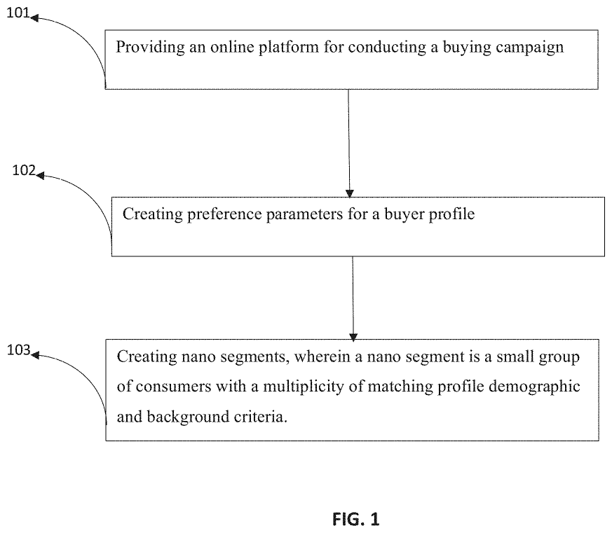

FIG. 1 illustrates the method of conducting a buying campaign of a cohort of a plurality of buyers and suppliers. Described herein is a method of conducting a buying campaign of a cohort of a plurality of buyers and suppliers. An online platform enables engagement, collaboration and sharing with buyers and suppliers 101. A lead moderator moderates the buying campaign. Preference parameters 102 and Nano Segments are created 103. A Nano Segment is a small group of consumers with a multiplicity of matching profile demographic and background criteria.

FIG. 2 illustrates the functional modules of the overall architecture of the computer implemented online platform. The admin module 201 will control the access of various users to the application. Functionality and processes available to users will be controlled and defined by the admin module 201. The user management module 202 contains information and profile of users who are allowed to access the application. This module will capture various attributes about the users which will be required in other modules and processes. The role management module 203 lists different roles and attributes that will be given to the users for accessing the application. The supplier management module 204 maintains supplier profiles. For example, the supplier management module 204 includes details of the company or individual, location, address, and other business critical information such as tax number and payment related attributes. The product management module 205 contains product catalogues of available saleable products. It will enable the registering of products by the admin. Products can be created by the admin, suppliers, and moderators. Products will have Nano Segments associated with them. The service management module 206 contains service catalogues of a list of saleable services. It will enable the registering service by the admin 201. New Services can be created by suppliers in the service catalogue. Services may have Nano Segments 207 associated with them. The Nano Segments 207 module will define the categories or segmentation that can be associated with users, products or services, campaign. The campaign management module 208 defines the campaign entity attributes, its relation with other modules as well as the behaviour of the campaign at each stage starting from the campaign creation up to the fulfilment. In the contract management module 209, contracts associated with the supplier will be maintained for providing service accepted at the time of campaign fulfilment. The contract management module 209 will track the processes related to contract creation and acceptance as part of the campaign management process. Concierge management will maintain the users with the role of concierge. Details of user profile, product and services offered by the concierges, location, address other business or service critical information attributes will be maintained for concierge. The order management module 210 defines products and services provided by the supplier in the contract as a response to the associated campaign. The payment management module 211 is associated with payment from users at campaign registration. The activity management module 212 enables the application to communicate with the users via email, alerts, SMS, and other social platforms at various process stages. The review and feedback module 213 enables communication with the users after successful execution of event described in the campaign, publishes the user comments and acts on areas of improvement for the future events or campaigns. The document artefact management 214 module is a file management for uploading the documents at various process stages. The reports and dashboards module 215 provides the visualization of user transactions and data in the application such as number of users registered, list of campaigns, and list of products. The underlying interface module 216 facilitates the application to interact with external applications 217 such as Whatsapp, Google, Facebook, payment gateway, and other applications for communication and data.

The communication module 218 generates notifications, alerts, text msgs and emails at various stages of the campaign. For example when a member registers for the campaign, the moderator will receive an email or sms notification about the same.

The social connector module 219 enables interaction with other social applications for collaboration e.g. with Twitter, Facebook or Whatsapp. For example, when a new campaign is created, the moderator can send the campaign link to Whatsapp or Facebook through such a social connector module 219.

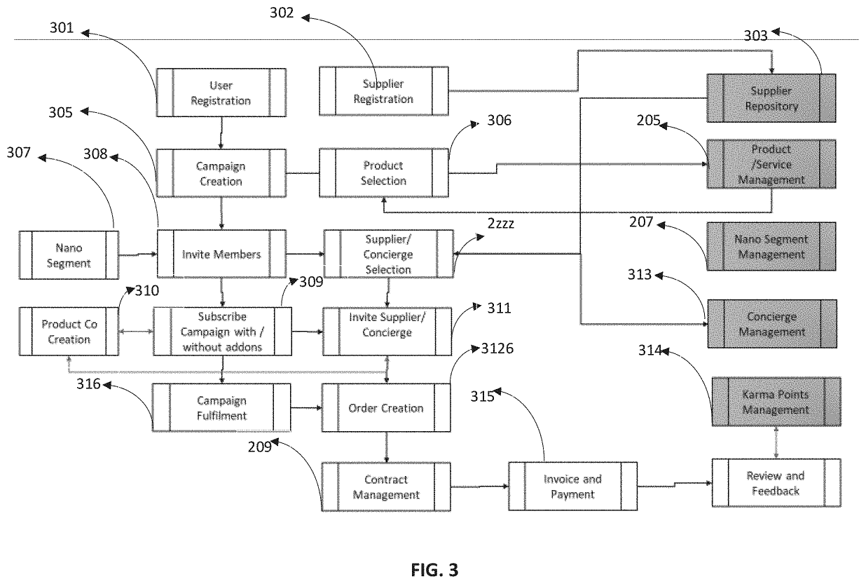

FIG. 3 illustrates the process solution for aggregating customers' demands for group buying of products or services in the online platform. The platform provides a solution for aggregating customer's demands for group buying of products or services. All the users will be registered in the application by the user registration process 301. All the suppliers will be registered in the application by the supplier registration process 302. The application administrator's verification is required for the supplier to be in supplier repository 303. The product service repository 304 can be accessed and modified by suppliers. All the products and services will be registered in the product service management repository 304. This catalogue is available to users to choose the products 306 or services. Users with access to create a campaign will create a buying campaign 305 in the application.

A Nano Segment 307 will be associated with each campaign. It will be used to identify the group of users to participate in the campaign. In order to invite members 308, once the campaign is created, it will be sent to social groups of people to subscribe. Campaign will be sent to other people via sms/Whatsapp/Facebook (or any other social applications) from where they can click the link, register and participate in the campaign. Members can subscribe to the campaign 309 and can customize the products by participating in product co-creation 310. The supplier or concierge can be invited 311 to the campaign to view the customer demand. The supplier or concierge can provide quotations to the bulk demand of products or services. The supplier will be selected by the campaign manager, i.e. the moderator. Supplier confirmation will lead to order creation 312 of the campaign. The order can be fulfilled by the supplier by providing the contract of offered services and products. The supplier will invoice the actual service provided to each buyer and receive payment, which will be routed in an integrated manner by the platform. Alternately, the supplier can raise a single invoice on the platform and in turn the platform will invoice each user for the services availed. The overall user experience will be measured in review ratings and feedback on the supplier products and services.

Concierge management 313 deals with aggregators of multiple products and services which are part of a single experience. For example, a vacation involves air travel, hotels, local transport, activities and food. These can be provided by multiple suppliers but can be integrated by a concierge for a nano segment. Moderators of the campaign may avail the concierge services for contacting suppliers and for negotiating on their behalf. The concierge management module 313 will maintain the profile and service catalogue of individuals or companies providing the services.

The campaign starts receiving responses and reaches to its minimum threshold. At this point, moderator starts contacting suppliers or concierges if required. The campaign fulfilment process 316 illustrates processing the campaign response into a group demand where suppliers can provide the best offer. The moderator and the suppliers negotiate on the platform to select the best suitable supplier, and supplier contracts will be undertaken. The moderator can take opinions of campaign participants through poll boards, likes, etc.

For fulfilled campaigns, suppliers will provide the services as per the group demand as well as add-on products and services offered to some members. The supplier or the platform will provide individualised invoices for each member. The platform will process the payments by buyers and provide a single payment to the supplier(s) against invoices raised by the supplier 315.

The purpose of karma points (or any such equivalent term to recognise users or build user loyalty) 314 is to motivate all participants to contribute meaningfully and positively to the overall experience of the campaign participants. Herein, all users' participation will be tracked and converted to karma points as per a karma menu. For example, the moderation of a campaign may have higher karma points 314 than a sub campaign moderator or a mere participant. As participants pick up activities to help the moderator, they can earn more karma points. Once the campaign is successful, campaign members will receive a notification to rate the overall experience. This rating will also be converted into Karma points 314. Feedback will be taken for suppliers as well as the moderator who was leading the campaign. Feedback (Stars awarded) will be converted to appropriate Karma points for the supplier and moderator. Higher Karma points for the supplier means higher potential for repeat business. Negative feedbacks given will be shared privately with the supplier to improve upon their services. Users can redeem their Karma points into different merchandize.

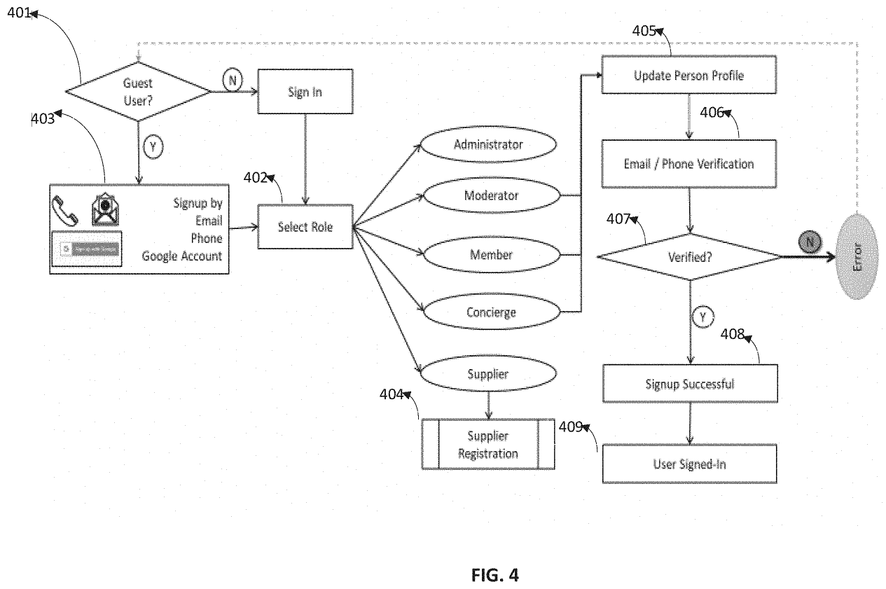

FIG. 4 illustrates the user registration process. Guest users 401 visiting the platform will be registering themselves through the user registration process to avail the services provided by the platform. If the user has already completed the registration process, they can sign in and select an appropriate role 402 in the application. The role of the user decides the access to the application processes. For example, a user with the role of “Moderator” will be able to create and publish a campaign whereas “Member” can participate in the campaign.

If the user is a guest and not registered, the user needs to sign up 403 either by email or phone number. Once role selection is done, the users will be appropriately directed for the user profile updating. If the role selected is supplier, “Supplier Registration” 404 process will start to guide the user to complete the details required for supplier profile. When the user profile is updated 405, email or phone number 406 will be verified 407 by the platform. Activation link will be sent to the email or mobile of the user, and after successful admin verification 408, the user will be registered 409 in the application.

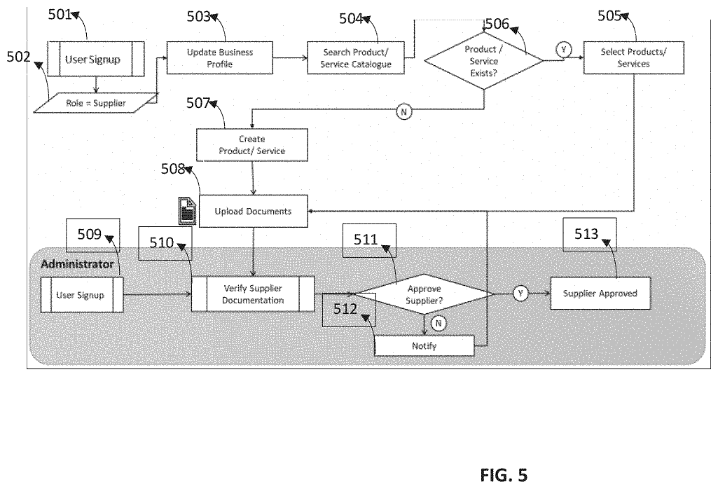

FIG. 5 illustrates the supplier registration process. The user sign up process 501 defines the role of the user 502. If the role selected by the user is a supplier, the user will be directed to the supplier registration process. The user will be asked to fill business profile details 503. Suppliers will have access to the product catalogue 504 where they can select the products and services 505 they offer. If the product or service is not existing 506 in the catalogue, they can create the product or service 507 as per their business requirement. For the registration of business, relevant documents will need to be uploaded 508 in the application. Once the documentation is available, the application administrator 509 will verify 510 the documentation. Based on the authenticity of documentation, supplier registration will be approved 511. In both cases of approval or rejection, notification 512 will be sent to supplier email or phone. After verification by email or phone, the supplier will be successfully registered in the application 513.

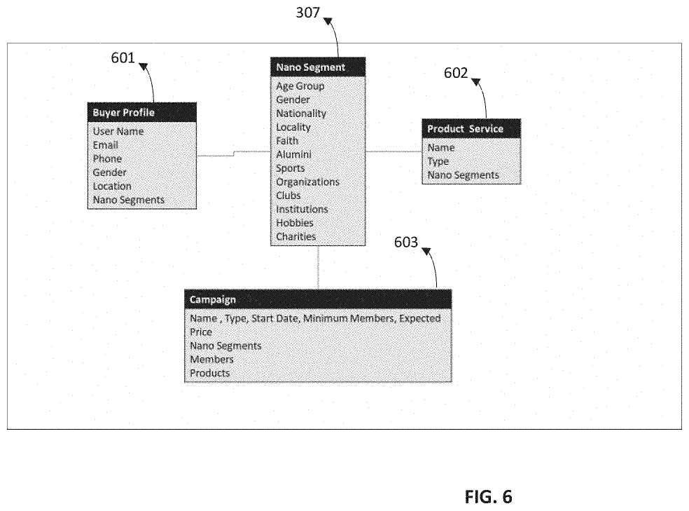

FIG. 6 illustrates Nano Segment relationships. The buyer profile 601 can be grouped based on common factors such as age group, gender, nationality, demographic location, neighbourhood, housing complex, sports, hobbies, interests, club memberships, institutions, alumni associations, life stage, children's age, children's sports, children's school, etc. This category is the criteria that “brings people together” as nano segments 307, and thus creates the need of group buying a product or service and provides a unique user experience. Hence, Nano Segment 307 forms a critical part of the user profile. It will also be associated with the product or service catalogue 602. The campaign 603 for group buying will be based on one or more of Nano Segments 307. Thus campaigns will collaborate the participating members based on the Nano Segment 307.

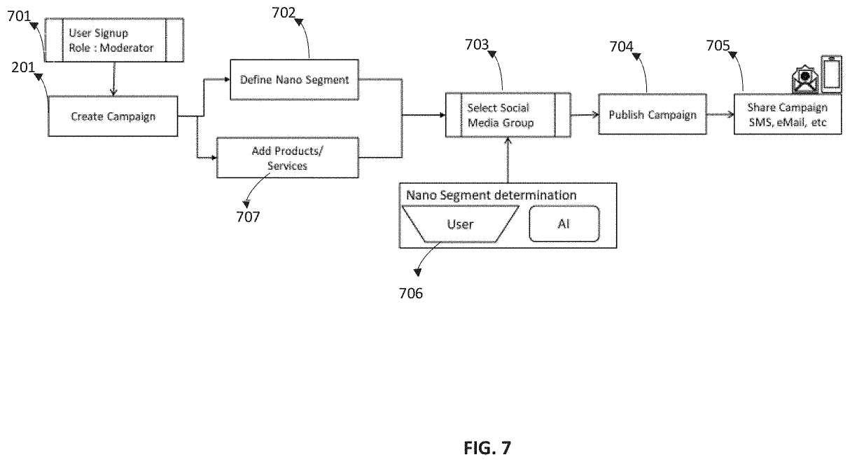

FIG. 7 illustrates the campaign creation that enables group buying. For any group buying event, the creator or initiator of the event logs 701 into the application with the “Moderator” role. This role has access to create a buying campaign. This role will define the nano segment or choose an existing nano segment for the campaign. Each campaign will be associated with a Nano Segment 307, 702, i.e. a category of people that would participate in the campaign.

The moderator will select the required products or services 707 in the campaign from the catalogue. Members who participate in this campaign will form a social group 703. This campaign will be published in the application 704. The group members will be notified by one or more of a link, SMS, or email to register and participate for the campaign 705. The Nano Segment 307 of the campaign will also play major role in providing a unique experience to each user participating in the campaign. Any user participating in a campaign is automatically associated with the nano segment defined for the campaign. These associations will be used by AI algorithms for recommendations. Hence more Nano Segments that can be associated with this event will be suggested by artificial intelligence (AI) algorithms 706. Moderators may select more Nano Segments based on the AI suggestions.

For example, the moderator creates a campaign of “Alumni Dinner” for the “alumni Batch xx” Nano Segment. Products such as buffet dinner is added to the campaign. Since it's a dinner event, meal preference will be another Nano Segment that can be associated in the campaign.

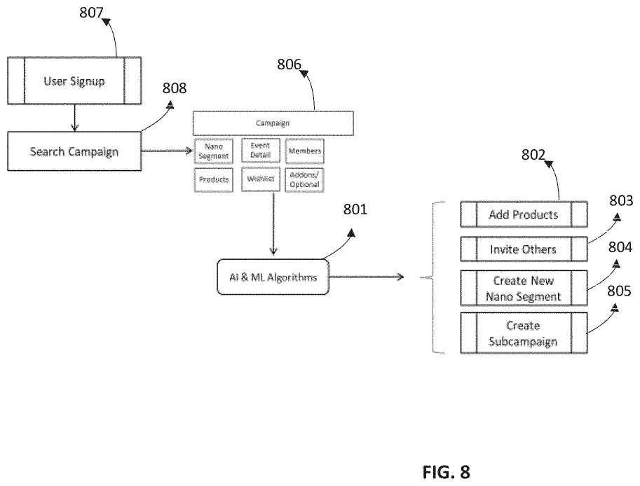

FIG. 8 illustrates campaign management. The online platform creates a unique user experience based on the buying campaign. The campaign 806 once created will be associated with machine learning (ML) algorithms 801. New Nano Segments 307 based on users participating in the campaign can be determined. Also AI suggestions may help moderators to add new products 802, people 803, Nano Segments 804 and new sub-campaigns 805 to the existing campaign. The online platform enables customization of the campaign.

The user signup 807 process illustrates the steps when a user visits the platform for the first time. Guest users will have some level of access to the application. However when a user wants to create any transaction, such as create a campaign or view the campaign, this process guides the user to sign up via entering an user id or email or mobile number, or any such convenient mechanism. If a user has already completed the user signup process 807, the next time onwards they will have to sign in.

Search campaign 808—this illustrates when user signs in with a particular role they can find the campaign. Various aspects of the campaign can be viewed. For example, moderator can view a the members details, suppliers info whearas members can view their own data to edit the same. Users can join a public campaign directly while they can request to be added to a private campaign. The moderator takes the decision to allow or reject such requests in the overall interest and alignment of the participating members of the nano segment.

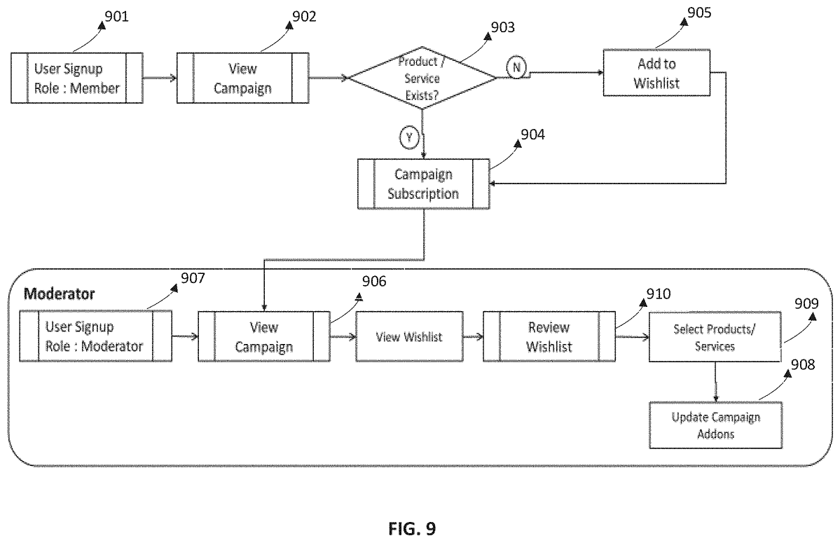

FIG. 9 illustrates addon products and services. Once the campaign is created by the moderator, the social group of users get notification to subscribe the campaign. Users receiving the notification or link can login into the application following the user registration process described earlier. The user signs 901 in with “Member” role to participate in the campaign, and views 902 the products and services 903 that are part of the campaign. If one wants to be part of the campaign, they can subscribe to the campaign 904. However, the online application platform allows the members to customize the campaign. They can review the wish list 910, and add relevant products or services of their choice to the wish list 905 for the campaign. Members can vote on wish list items. If a wish list item reaches a certain level of interest, it can be added to the main campaign products/services. As more participants sign in, the wish list of the campaign 906 will grow and the main products and services will also evolve. The moderator 907 will review the wish list 910. Common wish list items will be added as “Add on Products” in the campaign and the campaign addons will be updated 908. Lower interest wish list products can be provided as an option or as a selection 909 for the members subscribing to these specific options. However, servicing these personalised options will be at the discretion of the supplier, who will indicate the serviceable options before the contract is finalised.

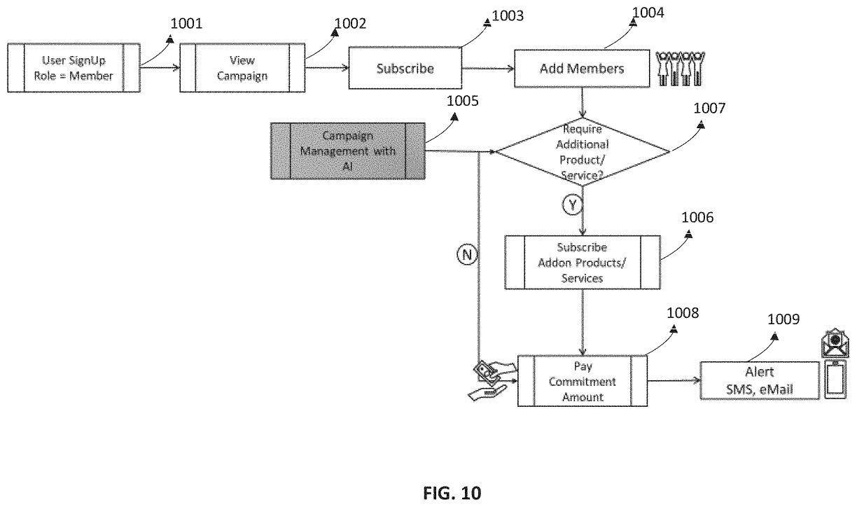

FIG. 10 illustrates a subscribe campaign. Users signing in as “Member” 1001 will view the campaign 1002 and can subscribe to it. They can add more members 1004 to the campaign. The application, i.e. the website or mobile app that will be developed for the online platform, provides them a choice to subscribe 1003 for add on products or services, or they can add the products to wish list. An AI module 1005 may provide suggestions 1007 to the member to subscribe for additional products 1006 based on the Nano Segment associated with the member. Once the member subscribes to a campaign, a commitment amount will be paid 1008 and the moderator will be notified 1009 for the same.

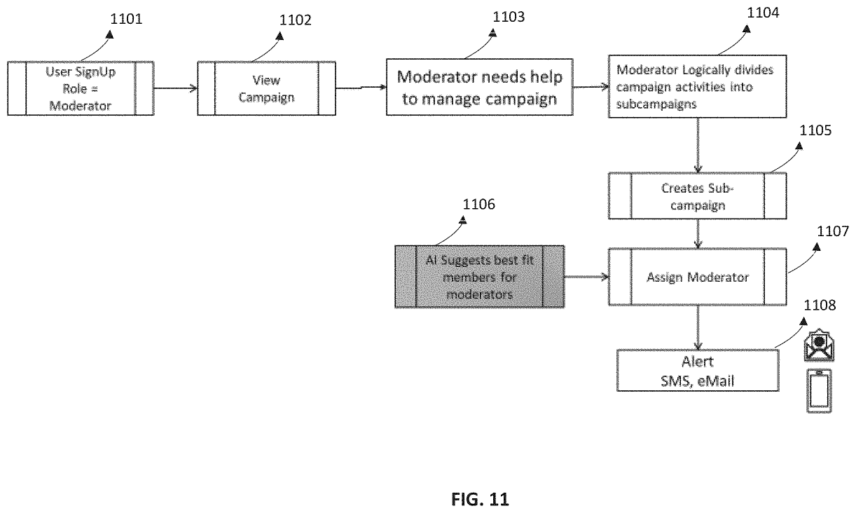

FIG. 11 illustrates a sub campaign creation. The moderator signs 1101 in to view the campaign 1102 and reviews the response. Depending on the complexity of the event, the moderator may seek help 1103, and depending on the number of people and logistics, the moderator can create a subcampaign 1104 to manage different activities under the campaign. One moderator will be assigned to the subcampaign. AI suggests a best fit member as a moderator 1106 for the subcampaign based on feedback ratings and karma points maintained by the application. The moderator for the subcampaign is assigned 1107 and notified 1108 to manage the sub activity in the campaign.

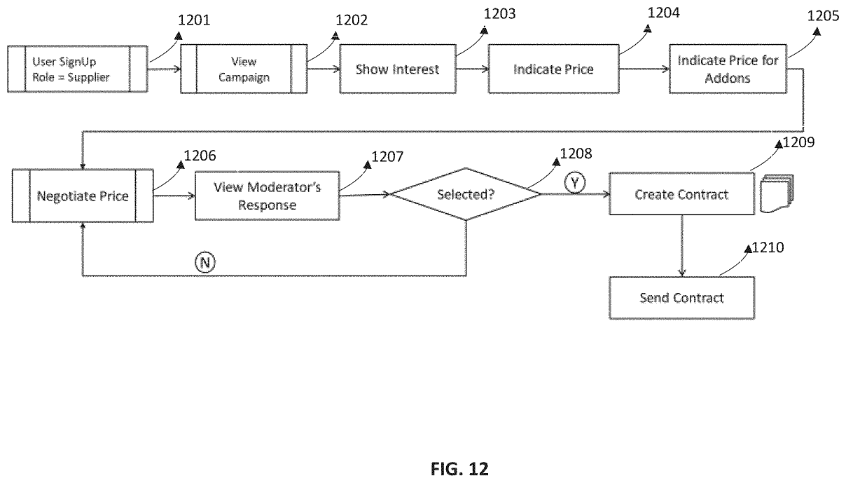

FIG. 12 illustrates campaign fulfilment by a moderator. The campaign subscribed by minimum members defined will qualify for campaign fulfilment. When suppliers sign in the application, they can see the campaign 1202 details, and required products and services. Suppliers 1201 can show interest 1203 in the campaign and indicate the price 1204 for the required products and addon products 1205 in the campaign. The moderator can view the suppliers' responses 1207 and indicative prices for the campaign. The price can be further negotiated 1206 with the supplier. When the moderator selects 1208 a particular supplier for fulfilling the campaign, the supplier will be notified for providing the quotation or contract 1209. Once the contract is agreeable to both supplier and moderator, the moderator will accept the offer and create the order for the supplier 1210.

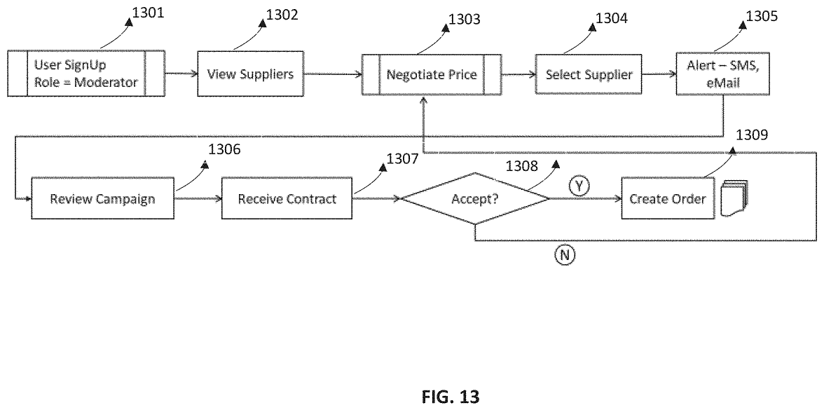

FIG. 13. illustrates the campaign fulfilment process. Once the campaign reaches its minimum size, the moderator, after signing up 1301, will look for the suppliers 1302 for the products/services in the campaign. The campaign will be visible to the suppliers and suppliers having products/services in area of interest. The moderator will receive the notification 1305 for the suppliers showing interest in the campaign. Moderator collaborates with the supplier to select the best offer 1303. Once the supplier is finalized, supplier will create the contract for providing the services in the decided timelines. If the contract is reviewed 1306, 1307 and accepted 1308 by the moderator, campaign will be said to be fulfilled. Next step is create order 1309 for the agreed products and services for the selected supplier.

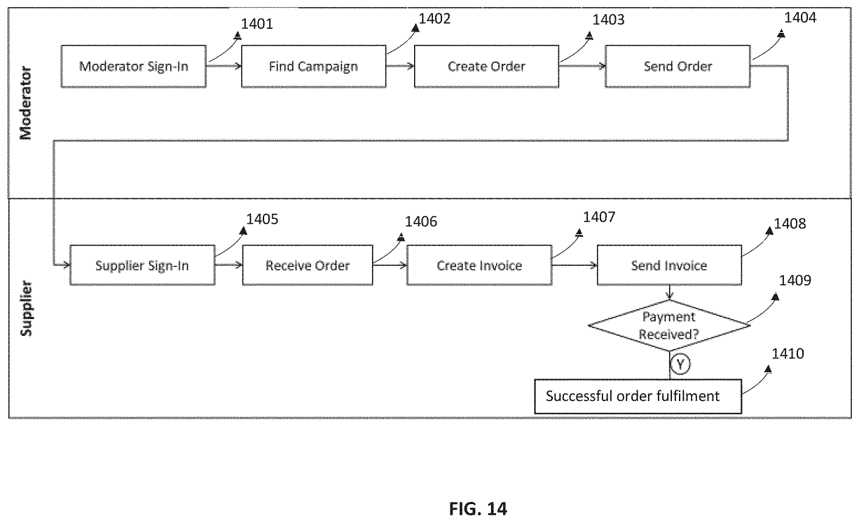

FIG. 14 illustrates the ordering process in campaign fulfilment. Once the supplier is selected for the campaign and the contract is signed, the campaign is said to be fulfilled. The moderator after signing in 1401, will find a campaign 1402 and will create an order 1403 from the fulfilled campaign and will send the order 1404 to the supplier. The supplier, after signing in 1405 will provide the services or products on receiving the order 1406. An invoice will be created 1407 by the supplier for the actual services and products provided. An invoice is sent 1408, and if the payment is received 1409, the order is shipped 1410. Platform will make it easier for suppliers by collecting payments from all buyers in a campaign, and making a single payment to the suppliers. The platform will pay to the supplier post successful and satisfactory delivery of services.

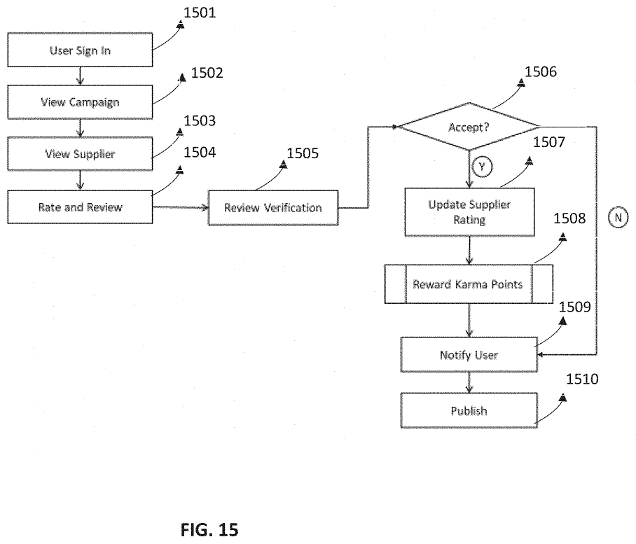

FIG. 15 illustrates the review and feedback process. The completion of the event mentioned in the campaign is followed by review and feedback from the signed in users 1501. Users will view the campaign 1502 and supplier 1503, thereafter they will rate and review 1504, and receive notification on their registered phone number or email to provide feedback. The feedback provided will undergo verification 1505 with the application admin. After verification and acceptance 1506, feedback will be available to view for the supplier and will add to the rating 1507. Karma Points will be awarded 1508 as per the satisfaction level and feedback received, and the supplier will be notified 1509 for the same, and the feedback results will be published 1510.

The following example illustrates the working of the ecommerce platform. For example, members of the Atlanta based Indian community are planning to visit India on Christmas. This plan is made months in advance and flights are to be booked by everyone without knowing how many others are going too. Potential customers need a way to discover and collate the known and committed demand from fellow consumers in their vicinity to collectively offer a deal to airlines to create a custom package for them. The following win-win possibilities arise if known and committed demand is offered to an airline. (a) An airline can offer a special price to the consumers' nano segment for committed demand. (b) An airline could run a special nonstop flight from Atlanta to Mumbai to cater to a large demand. (c) A charter airline could do two way runs to take passengers to Mumbai; and bring holiday season US expats to India if the same demand commitment model runs on both shores. (d) For a known customer set, additional experiences could be customised e.g. Indian food, Indian movies, Indian staff, etc. A consumer creates a campaign on the online platform on behalf of a group of consumers for which a minimum threshold of X will be kept. X could be the capacity of the aircraft. The campaign is easy to create. Use a social account creation, choose/detect location, select product, timing of purchase, and expected price. Pay a moderator defined commitment price Y (for example Y=100 USD). Add X people to the campaign who will require to sign up and pay the commitment price. The initial set of consumers promotes the campaign URL through social media such as Whatsapp groups, Facebook group, etc to closed groups. People can sign up and pay a commitment price. Once the campaign reaches a minimum threshold, moderators are offered a choice to publish the campaign to selected sellers. These sellers can view all the campaign details and make offers. These offers could be not just price but price plus other services offers. The campaign nano segment can see the offers and vote on these. Additional features can be added to the campaign before publishing the campaign to the sellers.

This model of known and committed demand offers a win-win to consumers and service providers alike. Consumers get better deals, customised packages, and convenience. Sellers save money on campaigns, get predictable demand, can plan better and can provide a better experience to highly converged consumer segments. Sellers can also offer alternative product-price points on the same campaign to assess their potential offerings.

The platform is intended to be profitable from the early stages. Revenues are generated as follows. Commission in lieu of giving bulk demand to sellers saving money on price promotions, advertising and campaigns. The platform can invest consumer committed funds in money markets to generate interest income.

It is apparent in different embodiments that the various methods, algorithms, and computer programs disclosed herein are implemented on non-transitory computer readable storage media appropriately programmed for computing devices. The non-transitory computer readable storage media participate in providing data, for example, instructions that are read by a computer, a processor or a similar device. In different embodiments, the “non-transitory computer readable storage media” also refer to a single medium or multiple media, for example, a centralized database, a distributed database, and/or associated caches and servers that store one or more sets of instructions that are read by a computer, a processor or a similar device. The “non-transitory computer readable storage media” also refer to any medium capable of storing or encoding a set of instructions for execution by a computer, a processor or a similar device and that causes a computer, a processor or a similar device to perform any one or more of the methods disclosed herein. Common forms of the non-transitory computer readable storage media comprise, for example, a floppy disk, a flexible disk, a hard disk, magnetic tape, a laser disc, a Blu-ray Disc® of the Blu-ray Disc Association, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

In an embodiment, the computer programs that implement the methods and algorithms disclosed herein are stored and transmitted using a variety of media, for example, the computer readable media in various manners. In an embodiment, hard-wired circuitry or custom hardware is used in place of, or in combination with, software instructions for implementing the processes of various embodiments. Therefore, the embodiments are not limited to any specific combination of hardware and software. The computer program codes comprising computer executable instructions can be implemented in any programming language. Examples of programming languages that can be used comprise C, C++, C#, Java®, JavaScript®, Python®, hypertext pre-processor (PHP), Microsoft® .NET, Objective-C®, Django, Scala, R, Keyclock, React Native, Angular, etc. Other object-oriented, functional, scripting, and/or logical programming languages can also be used. In an embodiment, the computer program codes or software programs are stored on or in one or more mediums as object code. In another embodiment, various aspects of the methods and the systems disclosed herein are implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. In another embodiment, various aspects of the methods and the systems disclosed herein are implemented as programmed elements, or non-programmed elements, or any suitable combination thereof.

The methods and the systems disclosed herein can be configured to work in a network environment comprising one or more computers that are in communication with one or more devices via a network. In an embodiment, the computers communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, examples of which are disclosed above, that are adapted to communicate with the computers. In an embodiment, each of the computers is equipped with a network communication device, for example, a network interface card, a modem, or other network connection device suitable for connecting to a network. Each of the computers and the devices executes an operating system, examples of which are disclosed above. While the operating system may differ depending on the type of computer, the operating system provides the appropriate communications protocols to establish communication links with the network. Any number and type of machines may be in communication with the computers.

The methods and the systems disclosed herein are not limited to a particular computer system platform, processor, operating system, or network. In an embodiment, one or more aspects of the methods and the systems disclosed herein are distributed among one or more computer systems, for example, servers configured to provide one or more services to one or more client computers, or to perform a complete task in a distributed system. For example, one or more aspects of the methods and the systems disclosed herein are performed on a client-server system that comprises components distributed among one or more server systems that perform multiple functions according to various embodiments. These components comprise, for example, executable, intermediate, or interpreted code, which communicate over a network using a communication protocol. The methods and the systems disclosed herein are not limited to be executable on any particular system or group of systems, and are not limited to any particular distributed architecture, network, or communication protocol.

The foregoing examples have been provided merely for explanation and are in no way to be construed as limiting the online platform and method disclosed herein. While the online platform and method has been described with reference to particular embodiments, it is understood that the words, which have been used herein, are words of description and illustration, rather than words of limitation. Furthermore, although the online platform and method has been described herein with reference to particular means, materials, and embodiments, the online platform and method is not intended to be limited to the particulars disclosed herein; rather, the design and functionality of the online platform and method extends to all functionally equivalent methods, structures and uses, such as are within the scope of the appended claims. While particular embodiments are disclosed, it will be understood by those skilled in the art, having the benefit of the teachings of this specification, that the online platform and method disclosed herein is capable of modifications and other embodiments may be effected and changes may be made thereto, without departing from the scope and spirit of the online platform and method disclosed herein.

We claim:

1. A computer implemented method of conducting a buying campaign of a cohort of a plurality of buyers and suppliers, comprising the steps of:
providing an online platform for conducting said buying campaign; through engagement, collaboration and sharing with said buyers and suppliers;
moderating said buying campaign by a moderator, further comprising the steps of;
creating preference parameters for a buyer profile; and
creating nano segments, wherein a nano segment is a small group of consumers with a multiplicity of matching profile demographic and background criteria.

2. The method of claim 1, wherein the step of setting preference parameters for a buyer profile to create a nano segment further comprises the steps of setting nano segments, characteristics and campaign details.

3. The method of claim 1 where a size of the nano segment is decided based on the optimum experience desired with an optimum size of buyer group.

4. The method of claim 1, wherein products, services or add on options for said buyer may be recommended by computer algorithms or machine learning driven bots to specific nano segments to create, optimize or enhance a desired experience.

5. The method of claim 1, wherein the step of creating preference parameters for a product profile further comprises the steps of identifying products that are most suitable for said buyer profile, preferences and interests, wherein these preferences and interests may be recommended by machine learning algorithms from past data existing on the online platform before creation of said product profile.

6. The method of claim 1, wherein said buyers and suppliers collaborate and co-create an experience that is highly fitted to the buyer's nano segment characteristics.

7. The method of claim 6, wherein said collaborating and co-creating step is coordinated by said moderator, and wherein the moderator may be supported by a machine learning algorithm or bot for a more intuitive experience.

8. The method of claim 1, wherein the buying campaign is divided into sub campaigns for handling a specific product or service purchase.

9. The method of claim 8, wherein said moderator assigns responsibility of said sub campaign to another buyer from within the group, and wherein said assignment is derived from karma points and engagement score, and wherein an algorithm recommends buyer(s) with high propensity to complete sub campaign tasks, to the moderator.

10. The method of claim 1, wherein said online platform handles collection from said buyers and conducts payment to said suppliers.

11. The method of claim 1, wherein the online platform becomes a transacting entity through the moderator, making it convenient for a supplier to conduct transactions with a single entity, and wherein the online platform may also negotiate on the buyer's behalf with suppliers.

12. The method of claim 1, wherein said online platform generates revenues from the suppliers' commission and enables subsequent business connections.

13. The method of claim 1, wherein a minimum threshold of buyers is set after which said buying campaign is presented to the suppliers.

14. The method of claim 1, wherein the online platform suggests groups to the moderator based on buyers profile, preferences, liking, interests and exhibited behaviour.

15. The method of claim 1, wherein a nano segment size is fixed as a maximum limit of buyers, and the campaign is closed for prospective buyers after said maximum limit is realized.

16. The method of claim 1, wherein the moderator can seek services of a third party concierge, wherein said third party concierge helps with a procurement process of specific custom needs of the nano segment by bringing relevant suppliers on the platform to collaborate with the nano segment.

17. The method of claim 1, wherein a buying campaign will collect a commitment amount from each of the buyers, and said commitment amount will be utilized to pay the supplier once the services have been delivered.

18. The method of claim 1, wherein the online platform partners with a financial institution to provide an online loan to the buyer or provide an option of bill discounting, and wherein decision making of the loan approval or bill discounting will be enabled by the assessment of the nano segment characteristics by said financing institution.
